(19) United States
(12) Patent Application Publication
(10) Pub. No.: US 2012/0119651 A1
(43) Pub. Date: May 17, 2012

(54) LED LIGHTING DEVICE AND LED LIGHTING EQUIPMENT

(75) Inventors: Hiromichi Nakajima, Kanagawa-Ken (JP); Naoko Iwai, Kanagawa-Ken (JP); Masahiko Kamata, Kanagawa-Ken (JP); Sayaka Tomiyama, Kanagawa-Ken (JP); Toru Ishikita, Kanagawa-Ken (JP); Toshikiko Sasai, Kanagawa-Ken (JP)

(73) Assignee: TOSHIBA LIGHTING & TECHNOLOGY CORPORATION, YOKOSUKA-SHI (JP)

(21) Appl. No.: 13/294,205

(22) Filed: Nov. 11, 2011

(30) Foreign Application Priority Data
Nov. 12, 2010 (JP) 2010-254324

(51) Int. Cl. H05B 37/03

(52) U.S. Cl. 315/122

(57) ABSTRACT

In one embodiment, a lighting device includes an LED lighting circuit and an LED load constituted by a plurality of parallel circuits formed by connecting a plurality of LED elements in parallel, and a series circuit formed by connecting the parallel circuits. The series circuit is connected with an output terminal of the lighting device. In case one LED element becomes open fault mode in one of the parallel circuit, the other LED elements continue lighting. In case two or more LED elements become the open fault mode, the other LED elements also become the open fault mode, and all the LED elements turn off.

### CROSS-REFERENCE TO RELATED APPLICATION

This application is based upon and claims the benefit of priority from prior Japanese Patent Application No. 2010-254324, filed Nov. 12, 2010, the entire contents of which are incorporated herein by reference.

### FIELD

Embodiments described herein relate generally to a LED lighting device and a lighting equipment.

### BACKGROUND

when using many LED elements to obtain desired light amount, a plurality of load circuits formed of a series circuit of two or more LED elements are connected to an output end of an LED lighting circuit through a balancer, respectively, and the lighting can be made.

However, since a balancer is needed for every load circuit in this case, the cost of the LED lighting equipment is raised. Further, since an electric power loss also arises in the balancer, the circuit efficiency falls. Moreover, since mounting of the balancer is needed, the structure of a mounting board where circuit components are mounted is complicated, and a measure is also needed against a rise in heat of the mounting board due to heat generation of the balancer.

Moreover, as a single load circuit, a parallel circuit is formed with two or more LED elements, and the plurality of parallel circuits is series connected. The both ends of the single load circuit may be connected to the output end of the LED lighting circuit to light on.

In this case, if an open fault mode occurs in an LED element, the current shunts in other LED elements. Accordingly, other LED elements continue lighting, but optical output shows variations due to variations of If current between the LED elements, which are caused by variations in a Vf characteristic of the LED element. Moreover, if the current flowing in the other LED elements becomes in an excessive electrical overload state, the rise in heat of the LED element becomes high too much, and the life of the LED element becomes short.

Furthermore, the plurality of LED elements is also cross connectable with a plurality of wirings extending from both end terminals of the LED lighting circuit through the balancer.

However, although the other LED elements can be made to turn on at the time of the open fault mode or the short circuit mode of the LED element in this case, the load circuit becomes complicated. Therefore, not only the same problem as the above-mentioned connecting method is caused because it is necessary to use a plurality of balancers, but the wiring structure becomes complicated because it is necessary to make a bridge circuit arranged in the middle of the wirings.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a block circuit diagram according to a first embodiment.

FIG. 2 is a circuit diagram showing a mounting state of a LED load according to a second embodiment.

FIG. 3 is a circuit diagram showing the mounting state of the LED load according to a third embodiment.

### DETAILED DESCRIPTION

A LED lighting device and a lighting equipment according to an exemplary embodiment of the present invention will now be described with reference to the accompanying drawings wherein the same or like reference numerals designate the same or corresponding portions throughout the several views.

According to one embodiment, a lighting device includes: an LED lighting circuit; and an LED load including; a plurality of parallel circuits formed by connecting a plurality of LED elements in parallel, and a series circuit formed by connecting the parallel circuits in series, and connected with an output terminal of the lighting device, wherein in case one LED element becomes open fault mode in one of the parallel circuit, the other LED elements continue lighting, and in case two or more LED elements become the open fault mode, the other LED elements also become the open fault mode, and all the LED elements turn off.

### First Embodiment

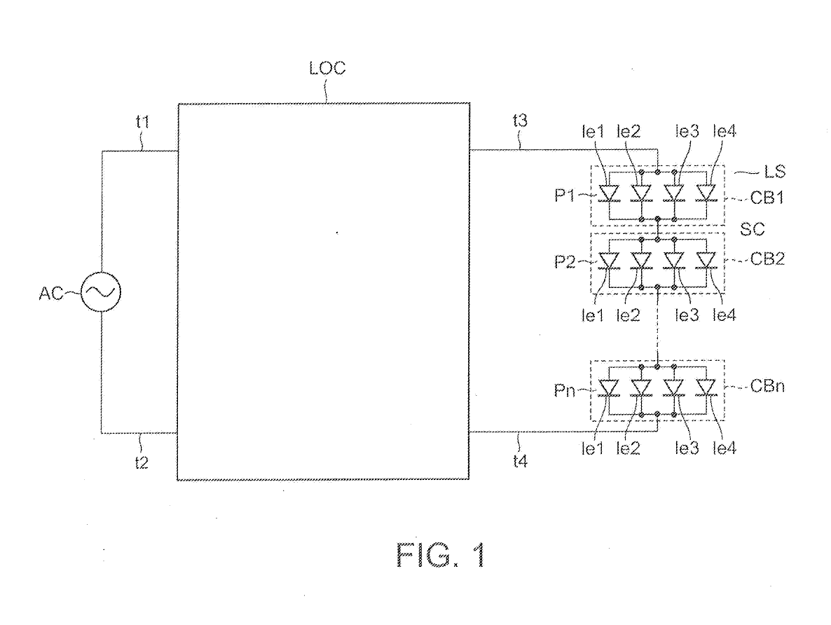

The first embodiment is shown in FIG. 1. In the figure, the LED lighting equipment includes a LED lighting circuit LOC and a LED load LS.

In the LED lighting circuit LOC, the input terminals t1 and t2 are connected to an alternating power supply source AC, and the output terminals t3 and t4 are connected to the LED load LS to be mentioned later. Moreover, the LED lighting circuit LOC is equipped with a constant current control function preferably in the inside, and is constituted so that load current is maintained uniformly. In addition, the LED lighting circuit LOC may be equipped with a direct-current power supply source which supplies the direct-current electric power to a DC-DC converter, for example, a step-down chopper, while using a known DC-DC converter as a main part.

The LED load LS includes a plurality of parallel circuits P1-Pn, respectively formed of a plurality of LED elements le1-le4 connected in parallel, and further includes single series circuit SC formed of the plurality of parallel circuits P1-Pn.

The plurality of parallel circuits P1-Pn is arranged in a relation in which the plurality of LED elements le1-le4 adjoin spatially, respectively. “the LED elements le1-le4 adjoin spatially, respectively” means that the plurality of LED elements le1-le4, for example, the LED elements le1 and le2 adjoining each other which constitute one parallel circuit are two-dimensionally or three-dimensionally arranged in an adjacent relation. Namely, it means the state in which luminescence from the adjacent LED elements le1 and le2 is mixed when looking from the lighted position.

Therefore, even if optical output varies among the LED elements le1-le4, the variation does not become problem practically because the variation is equalized and the light becomes easy to be visible. In addition, a structure, in which an optical diffusion board (not shown) is arranged between the parallel circuit P and a lighting position, is preferable because the emitted light is diffused and forms a good light mixing state even if the distance between the LED element le and the lighting position becomes small relatively.

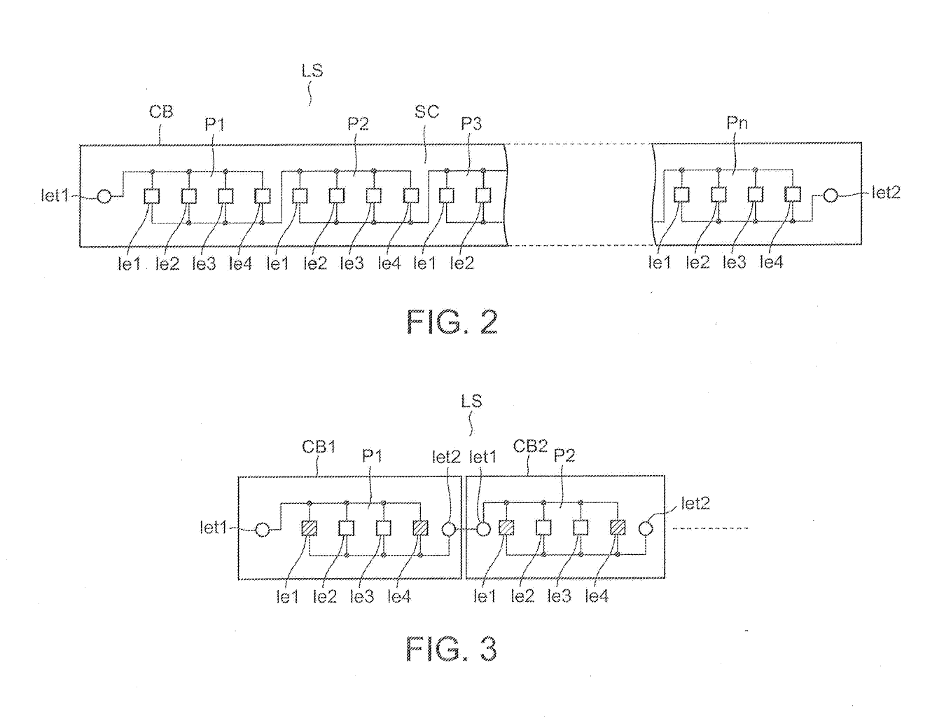

In order to make the plurality of LED elements le1-le4 of the parallel circuit P into the spatial relationship which adjoins mutually, it is preferable to mount the LED elements le1-le4 on the common substrate CB, for example, as shown in FIG. 2. However, as shown in FIG. 3, the substrate CB may be separated for every parallel circuit. Furthermore, all or a part of the plurality of parallel circuits P1-Pn may be mounted on the common substrate CB.

Moreover, when one LED element, for example, the LED element le1 becomes the open fault mode in one of the parallel circuit, lighting continues because load current shunts in the other LED elements le2-le4. On the other hand, when two or more LED elements, for example, the LED elements le1 and le2 become the open fault mode, the lighting device becomes the open failure mode because over-current which flows into the other LED elements le3 and le4 becomes extremely larger than a rated value. As a result, all the LED elements let-le4 of the parallel circuit P turn off. Accordingly, the load current is shut, and all the LED elements le of the LED load LS turn off.

In order to satisfy above condition, it is necessary to set up the number of the LED elements le arranged in parallel so that the current which flows into other LED elements le3 and le4 may be 1.5 or more times of the rated value of the LED element le when two or more LED elements le1 and le2 become the open fault mode. Moreover, if the current which flows into other LED elements le3 and le4 is 1.35 or less times of the rated value of the LED element le when one LED element le becomes the open fault mode, the other LED elements le continue lighting. As a consequence, the parallel number of the LED elements le linked to one parallel circuit P is 4-6 pieces preferably.

In the embodiment shown in figure, the current which flows into the LED element le at the usual time is 71 mA (79% of the rated value) lower than the rated value, 90 mA. When one LED element le of the parallel circuit P becomes the open fault mode, the current which flows into one of the other LED elements le is 95 mA (106% of the rated value). Moreover, when the two LED elements le become the open fault mode, the current which flows into one of the other LED elements le is 142 mA (158% of the rated value).

In addition, when one LED element among the plurality of parallel circuits P1-Pn, for example, the LED element le1 becomes the open fault mode, the other LED elements le2-le4 continue lighting by the above-mentioned reason. However, the other LED elements le2-le4 are still now an electrical overload state, though the extent is relatively small. Therefore, since the life of the other LED elements le2-le4 may be shortened, it is preferable to find out and restore the open fault mode as soon as possible.

On the other hand, when the LED element le becomes the short circuit fault mode, the parallel circuit P in which the LED elements le are formed becomes the short circuit mode, but when the LED lighting circuit LOC performs the constant current control, the other parallel circuits P continue lighting normally.

### Second Embodiment

The second embodiment is explained with reference to FIG. 2. In addition, the same mark is attached about the same portion as FIG. 1, and explanation is omitted. In this embodiment, the plurality of parallel circuits P1-Pn is mounted on the common substrate CB. The common substrate CB shown in figure is long and thin, and terminals let1 and let2 are provided in the both ends. All the LED elements le1-le4 provided in the respective parallel circuits P1-Pn between both terminals let1 and let2 are arranged on a virtual straight line between the terminals let1 and let2 at a constant interval. Moreover, respective parallel circuits P1-Pn are series connected. Therefore, the LED load LS is altogether mounted on the common substrate CB, and if both terminals let1 and let2 are connected to the ends t3 and t4 of the LED lighting circuit LOC, the LED load LS can be turned on.

According to this embodiment, the plurality of LED elements le1-le4 of each parallel circuit P is two-dimensionally arranged in the adjacent relation. Therefore, even if optical output varies among the LED elements le1-le4, the variation does not become problem practically because the variation is equalized and the light becomes easy to be visible like the first embodiment.

Moreover, in this embodiment, while performing the same operation and effect as the first above-mentioned embodiment, it becomes possible to emit the light with almost equal optical output along with a line because the LED elements le1-le4 of each of the plurality of parallel circuits P1-Pn are arranged on the common substrate CB with a constant interval and in the shape of a straight line. Furthermore, the LED load LS with easy handling can be offered by mounting it on the single board.

### Third Embodiment

The third embodiment is explained with reference to FIG. 3. In addition, the same mark is attached about the same portion as FIG. 2, and explanation is omitted. In this embodiment, a plurality of parallel circuits P1, P2 . . . are arranged on the independent long and thin boards CB1, CB2 . . . so that the respective LED elements le1-le4 are arranged and mounted at a constant interval on the straight line. In addition, respective substrates CB1, CB2 . . . are equipped with terminals let1 and let2 at respective ends.

In each of the parallel circuits P1, P2 . . . , the LED elements le1 and le4 (shown in hatching in figure) with relatively low Vf at the time of rising in a Vf characteristics are arranged in the positions which adjoin both terminals let1 and let2, and the LED elements let and le3 with high Vf at the time of rising are arranged in the middle position.

In the LED elements le1 and le4 with relatively low Vf at the time of rising in the Vf characteristics, current shunting ratio becomes large relatively in the respective parallel circuits P. Accordingly, the light output becomes large relatively when lighting on. On the contrast, in the LED elements le2 and le3 with high Vf at the time of rising, the current shunting ratio becomes small relatively in the respective parallel circuits P. Accordingly, the light output becomes small relatively when lighting on.

If the parallel circuits P1, P2 . . . are series connected while arranging the substrate CB1, CB2 . . . in a straight line along a longitude direction, and connecting in series, all the LED elements le are arranged in a line like the second embodiment.

According to this embodiment, the distance between the LED elements le4 and le1 which adjoin the terminals let2 and let1 provided in a pair of adjoining substrates CB1 and CB2, respectively becomes larger than the distance between the LED elements le2 and le3 in each of the substrate CB1 and CB2. However, almost the same operation and effect can be obtained if the plurality of substrates CB1, CB2 . . . are arranged in a line and connected in series. Furthermore, the LED load LS of the shape of almost same line as the second embodiment can be offered.

Moreover, since the substrate CB is separated into every parallel circuit P, the various types of LED loads LS can be also offered having the shapes such as an L character shape and a U character shape, not only the direct line shape.

Next, the embodiment applied to a lighting equipment is explained. The lighting equipment includes a main body of the lighting equipment, and the LED lighting device of the above-mentioned embodiment implemented in the main body of the lighting equipment. The lighting equipment according to the embodiment is applicable to various type lighting equipments containing a light source. The main body of the lighting equipment means the portion of the LED lighting equipment in which the lighting device is removed from the lighting equipment. Moreover, the LED lighting circuit of the LED lighting equipment may be arranged in a position apart from the main body of the lighting equipment.

According to the above-mentioned embodiment, when one of the LED elements becomes the open fault mode, the lighting continues because the over-current is small even if the current shunts in the other LED elements. However, when more than two LED elements become the open fault mode, the other LED elements become the extremely over-current state, and consequently become the open fault mode. Finally, the light is put out. As a result, the LED elements of all the parallel circuits connected in series turn off, and the safety of the circuit can be achieved. Furthermore, since the LED element load can be constituted by single circuit, the LED lighting device without the balancer can be offered, and the lighting equipment equipped with the above lighting device is also offered.

While certain embodiments have been described, these embodiments have been presented by way of embodiment only, and are not intended to limit the scope of the inventions. In practice, the structural elements can be modified without departing from the scope of the invention. Various embodiments can be made by properly combining the structural elements disclosed in the embodiments. For embodiment, some structural elements may be omitted from all the structural elements disclosed in the embodiments. Furthermore, the structural elements in different embodiments may properly be combined. The accompanying claims and their equivalents are intended to cover such forms or modifications as would fall with the scope of the inventions.

1. A lighting device, comprising:
an LED lighting circuit; and
an LED load including;
a plurality of parallel circuits formed by connecting a plurality of LED elements in parallel, and
a series circuit formed by connecting the parallel circuits in series, and connected with an output terminal of the lighting device,
wherein in case one LED element becomes open fault mode in one of the parallel circuit, the other LED elements continue lighting, and
in case two or more LED elements become the open fault mode, the other LED elements also become the open fault mode, and all the LED elements turn off.

2. The lighting device according to claim 1, wherein in case two or more LED elements become the open fault mode, the current flowing in the other LED elements is controlled by the number of the LED elements connected in parallel.

3. The lighting device according to claim 1, wherein the plurality of LED elements provided in the parallel circuits is arranged on a common substrate in a line adjoining each other.

4. The lighting device according to claim 1, wherein the LED elements with relatively low Vf at the time of rising in a Vf characteristics are arranged in the position which adjoins both terminals in each of the parallel circuit, and the LED elements with relatively high Vf at the time of rising are arranged in the middle position.

5. The lighting device according to claim 1, wherein the parallel circuits are arranged in an independent substrate having both end terminals in the both ends thereof respectively, and the both end terminals of the substrate are connected in series to the both end terminals of adjacent substrates.

6. The lighting device according to claim 1, wherein
the LED load is formed in a line shape such as a L character shape, and a U character shape.

7. A lighting equipment, comprising:
a main body; and
the lighting device according to claim 1 provided in the main body.

8. A lighting equipment, comprising:
a main body; and
the lighting device according to claim 2 provided in the main body.

9. A lighting equipment, comprising:
a main body; and
the lighting device according to claim 3 provided in the main body.

10. A lighting equipment, comprising:
a main body; and
the lighting device according to claim 4 provided in the main body.

11. A lighting equipment, comprising:
a main body; and
the lighting device according to claim 5 provided in the main body.

12. A lighting equipment, comprising:
a main body; and
the lighting device according to claim 6 provided in the main body.
